(19) United States
(12) Patent Application Publication
(10) Pub. No.: US 2026/0056512 A1
(43) Pub. Date: Feb. 26, 2026

(54) METHOD FOR PRODUCING A TIMEPIECE COMPONENT

(71) Applicant: ROLEX SA, Geneva (CH)

(72) Inventors: Denis Favez, Le Grand-Saconnex (CH); Yan Meng, Chavannes-Près-Renens (CH); Fabien Sorin, Ecublens (CH); Jérôme Krebs, Lausanne (CH); Inès Richard, Renens (CH)

(73) Assignee: ROLEX SA, Geneva (CH)

(21) Appl. No.: 19/305,700

(22) Filed: Aug. 20, 2025

(30) Foreign Application Priority Data
Aug. 23, 2024 (EP) 24196241.4

(51) Int. Cl. G04D 3/00; B21B 1/22; B21C 1/02; C22C 45/00; C22C 45/10; C22F 1/14; C22F 1/18; G04B 43/00

(52) U.S. Cl. CPC G04D 3/0089; B21B 1/22; B21C 1/02; C22C 45/003; C22C 45/10; C22F 1/14; C22F 1/186; G04B 43/007; G04D 3/0038; C22C 2200/02

(57) ABSTRACT

A method for producing a timepiece component (100) made of amorphous metal alloy, the production method comprising a step (E1) of producing a first preform made of amorphous metal alloy, then a step (E2) of hot drawing the first preform to obtain a second preform, then a step (E3) of machining the second preform.

### CROSS-REFERENCE TO RELATED APPLICATION

This application claims priority of European patent application No. EP 24196241.4 filed Aug. 23, 2024, the content of which is hereby incorporated by reference herein in its entirety.

### FIELD OF THE INVENTION

The invention relates to a method for producing a timepiece component. The invention also relates to a timepiece component obtained by such a method. The invention also relates to a regulating system comprising such a timepiece component. The invention further relates to a timepiece movement comprising such a regulating system or such a timepiece component. The invention lastly relates to a timepiece comprising such a timepiece movement or such a regulating system or such a timepiece component.

### BACKGROUND ART

Patent application EP3128035A1 proposes producing bulk amorphous alloys based on zirconium and/or hafnium, without nickel, or both without nickel and without beryllium. It notably proposes increasing the critical diameter Dc of these amorphous alloys by adjusting their composition, while maintaining a high Tx-Tg value. It states that the critical diameter Dc of the alloy must be larger than the largest dimension of a component.

Patent application CH716669A1 relates to a method for manufacturing a balance staff made of non-magnetic amorphous alloy (metallic glass), in which the molten alloy is injected into a cooled mold to obtain an amorphous structure, and then finished by one or more finishing steps. These are typically polishing or equivalent, optionally preceded by machining, and may include surface hardening by ion bombardment (C, O, etc.), PVD or carburization. The machining methods mentioned are those such as, for example, turning, bar turning or reworking after bar turning by means of cutting tools, or laser machining. It is also conceivable to vary the cooling rate in order to have an alloy which has a crystalline or partially crystalline core and is amorphous on the surface. The alloy Zr₅₇Cu₂₀Al₁₀Ni₈Ti₅ is mentioned as particularly advantageous.

Patent application EP3856426A1 describes the preparation of metallic glass wires of micro- and nanometric cross section by drawing. The particular feature of the method is the encapsulation, or cladding, of one or more metallic glass preforms with a material having a viscosity similar to the preforms at the drawing temperature. One of the benefits of this cladding is that of reducing instabilities (breakage, reflow) during the drawing. The cladding may be produced, for example, from a thermoplastic polymer or a mineral glass. This allows metallic glass wires to be drawn to a nanometric diameter continuously without breaking them. After the drawing, the cladding can be removed mechanically or chemically. Furthermore, the cladding may be retained to form a new hybrid material with one or more metal fibers. This composite may have advantageous properties, notably in the optical, electrical or electrochemical fields. The following bulk metallic glasses have been used in various exemplary embodiments: Au₄₉Ag_{5.5}Pd_{2.3}Cu_{26.9}Si_{16.3}, Pt_{57.5}Cu_{4.7}Ni_{5.3}P_{22.5}. The alloys Zr_{41.2}Ti_{13.8} Cu_{12.5}Ni₁₀Be_{22.5}, Pd₄₃Cu₂₇Ni₁₀P₂₀, Zr₃₅ Ti₃₀Cu_{8.25}Be_{26.75} have also been proposed as suitable for the production of micro- and nanometric wires. This patent application takes advantage of the combination of the viscous state of the metallic glass and of the cladding material at the drawing temperature in order to stabilize the formation of submillimetric wires.

### SUMMARY OF THE INVENTION

The aim of the invention is to provide a method for producing a timepiece component able to improve on the methods known from the prior art. In particular, the invention proposes a method for producing a timepiece component that allows the timepiece component to be produced from a metallic glass.

According to the invention, a method for producing a timepiece component is defined by point 1 below.
1. A method for producing a timepiece component made of amorphous metal alloy, the production method comprising:
   a step (E1) of producing a first preform made of amorphous metal alloy, then
   a step (E2) of hot drawing the first preform to obtain a second preform, then
   a step (E3) of machining the second preform.

Embodiments of the production method are defined by points 2 to 18 below.
2. The method as defined in point 1, wherein the amorphous metal alloy has a supercooling domain ΔTx=Tx−Tg greater than 40° C. or greater than 60° C. or greater than 100° C., Tx being the crystallization temperature and Tg being the glass transition temperature.
3. The method as defined in one of the preceding points, wherein the amorphous metal alloy is a Pd-based alloy, or a Pt-based alloy, or a Zr-based alloy, for example the following compositions given in atomic percentages:

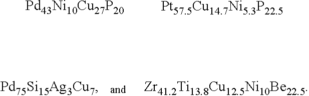

4. The method as defined in one of the preceding points, wherein the first step (E1) comprises a sub-step (E11) of structuring the first preform, in particular by machining or stamping.
5. The method as defined in one of the preceding points, wherein the first step (E1) comprises a sub-step (E12) of hardening the material of the first preform by a crystallization heat treatment, notably a partial crystallization heat treatment.
6. The method as defined in one of the preceding points, wherein the second step (E2) comprises hot drawing, notably at a temperature between the glass transition temperature and the crystallization temperature, without a die in order to obtain the second preform with at least one dimension of the second preform exceeding the critical diameter of the amorphous metal alloy by a factor greater than 5 or by a factor greater than 10 or by a factor greater than 100 or by a factor greater than 1000.
7. The method as defined in one of the preceding points, wherein the second preform is a rod or a bar or a wire, notably of circular cross section, with:
   a diameter greater than 1 mm or greater than 2 mm, and/or
   a length greater than 0.5 m or greater than 1 m or greater than 2 m.
8. The method as defined in one of the preceding points, wherein the step (E1) of producing the first preform made of amorphous metal alloy comprises cladding (E13) the amorphous metal alloy with a thermoplastic material, such as, for example, a polymer or a mineral glass.
9. The method as defined in the preceding point, wherein the machining step (E3) comprises a sub-step (E30) of removing the cladding, for example by dissolution, by chemical attack or by machining.
10. The method as defined in one of the preceding points, wherein the hot drawing step (E2) comprises a sub-step (E21) of hardening by a partial crystallization heat treatment.
11. The method as defined in one of the preceding points, wherein the method further comprises, between the hot drawing step (E2) and the machining step (E3), an additional shaping step comprising:
   a grinding sub-step (E60), and/or
   a sub-step of drawing through a die (E70).
12. The method as defined in one of the preceding points, wherein the machining step (E3) comprises machining with the application of a force, notably turning (E31).
13. The method as defined in one of the preceding points, wherein the machining step (E3) comprises rolling (E32).
14. The method as defined in one of the preceding points, wherein the machining step (E3) comprises cutting (E33) a toothing, for example cutting a pinion.
15. The method as defined in one of the preceding points, wherein the method comprises, after the machining step (E3), a step (E4) of hardening by a partial crystallization heat treatment.
16. The method as defined in the preceding point, wherein the method comprises, after the hardening step (E4), a finishing step (E5), notably by tribofinishing.
17. The method as defined in one of the preceding points, wherein the method comprises, after the machining step (E3), a finishing step (E5), for example a tribofinishing step.
18. The method as defined in one of the preceding points, wherein the method comprises a preliminary step (E0) of manufacturing a pre-alloy of the amorphous or partially amorphous alloy, for example by vacuum induction melting (VIM) or arc melting.

According to the invention, a timepiece component is defined by point 19 below.
19. A timepiece component, notably a shaft of a regulating system for a timepiece, such as a balance staff or a pallet staff or a mobile pinion, obtained by implementing the method as defined in one of the preceding points.

### BRIEF DESCRIPTION OF THE DRAWINGS

The appended drawings show, by way of examples, one embodiment of a timepiece according to the invention and one embodiment of a method for producing a timepiece component.

FIG. 1 is a schematic view of a timepiece according to the invention.

FIG. 2 is a time-temperature-transformation diagram of an alloy capable of forming a metallic glass.

FIG. 3 is a time-temperature-transformation diagram, like the one in FIG. 2, in which heat treatments have been represented by lines.

FIG. 4 is a flow diagram of one embodiment of a production method according to the invention.

### DETAILED DESCRIPTION OF PARTICULAR EMBODIMENTS

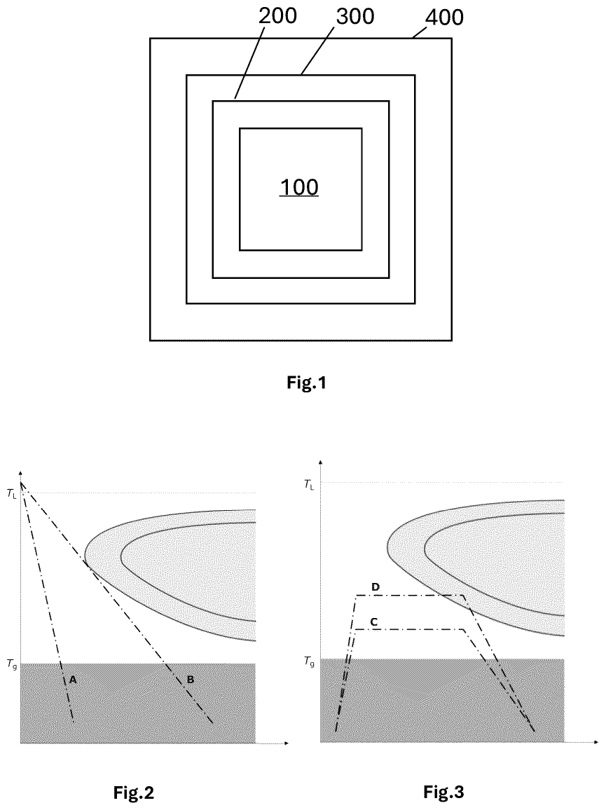

One embodiment of a timepiece 400 is described in detail below with reference to FIG. 1.

The timepiece 400 is for example a watch, in particular a wristwatch. The timepiece 400 comprises a timepiece movement 300 intended to be mounted in a timepiece casing or case in order to protect it from the external environment.

The timepiece movement 300 is a mechanical movement, notably an automatic movement, or a hybrid movement.

The timepiece movement 300 comprises a regulating system 200, notably a regulating system comprising:
an oscillator, in particular a sprung-balance oscillator, and
an escapement, in particular an escapement comprising at least one escape wheel and a pallet assembly.

The regulating system 200 comprises at least one timepiece component 100 obtained by implementing the production method which is the subject of the invention. The timepiece component 100 is for example a shaft, notably:
a balance staff, or
an escape wheel shaft, or
a pallet arbor or staff.

The regulating system 200 may thus comprise all or some of the components below, produced according to the method which is the subject of the invention:
a balance staff, and/or
an escape wheel shaft, and/or
a pallet arbor or staff.

The timepiece component 100 may also be a pinion of a mobile, notably an escape wheel pinion.

The timepiece movement 300 may alternatively be of the electronic type and comprise a timepiece component 100 produced according to the method which is the subject of the invention.

Several studies have shown that magnetic fields can disturb the running of a mechanical watch, mainly due to the impact on its regulating system. The components of the latter that are most sensitive to magnetic fields are the balance-spring, the escape wheel and the pallet assembly. The sensitivity to magnetism of the shafts of these elements plays a crucial role. This is why it is essential to make these shafts insensitive to magnetism.

To this end, the invention relates in particular to a method for manufacturing or producing a non-magnetic timepiece component, in particular a shaft intended for the mobiles of the regulating system of a timepiece. This method is noteworthy in that it makes it possible to take advantage of the thermal stability of bulk amorphous metals, also called bulk metallic glasses, in order to allow the drawing of billets to obtain bars, which are then machined by a traditional method, in particular by bar turning, to obtain timepiece shafts. Such a manufacturing or production method may comprise four steps:
1) manufacturing or producing a first preform made of bulk amorphous metal with a cross section of dimensions greater than typical timepiece dimensions, notably with a cross section of centimetric dimensions (for example, a diameter between 0.6 cm and 5 cm, respectively with a surface area of between approximately 0.3 cm² and 20 cm²),
2) hot drawing this first preform in order to obtain a second preform with a cross section of dimensions approximating the dimensions of a timepiece component, notably with a cross section of millimetric dimensions (for example, a diameter between 1 and 5 mm, respectively with a surface area of between 0.8 mm² and 20 mm²),
3) machining a shaft from the second preform by bar turning,
4) tribofinishing.

The material of the shafts of the mobiles of the regulating system of the timepiece should, inter alia, ideally have the following properties:
be non-magnetic,
have good mechanical properties, notably good shock resistance and compression strength,
have excellent tribological behavior,
be easily shaped with low tolerances, typically by bar turning,
have good corrosion resistance.

The traditional material of the shafts of the mobiles of the regulating system is quenchable free-cutting steel (for example 20AP or Finemac). However, these materials are magnetic, which is critical for the running of a timepiece. In addition, they are sensitive to moisture, requiring the use of particular packagings, for example under a protective atmosphere. Moreover, these materials are machined in a ferritic state which is too soft with respect to the requirements required for mobile shafts. It is therefore necessary to harden them all the way through using a quenching and tempering treatment, before a rolling step.

Amorphous metals are generally harder all the way through than crystalline alloys. These materials exhibit unique mechanical properties such as a high elastic limit, a high hardness and an elastic deformation close to 2%.

Amorphous metal alloys can have good properties in terms of insensitivity to magnetic fields depending on their composition. These alloys therefore have strong potential to replace quenchable free-cutting steels inter alia for applications regarding mobile shafts of a timepiece regulating system.

However, it has not been possible to use amorphous metal alloys until now, using standard machining techniques.

FIG. 2 illustrates, by means of a time (on the abscissa axis)-temperature (on the ordinate axis)-transformation diagram, the four phases in which an alloy capable of forming a metallic glass can be found:
liquid (above the temperature threshold TL),
amorphous (below the temperature threshold Tg),
crystalline (top right in the zone delimited by the curved shapes), and
supercooled liquid (elsewhere on the diagram).

The dash-dotted lines illustrate temperature-time profiles during cooling steps. Line A illustrates cooling to obtain an amorphous state. Line B illustrates critical cooling (the lowest cooling rate for achieving a completely amorphous structure).

In FIG. 3 showing the same diagram, dash-dotted lines illustrate temperature-time profiles during steps of hot drawing (line C) and of partial crystallization heat treatment (line D).

The applications of metallic glasses are limited because of the difficulties in implementing such alloys. The amorphous structure that characterizes these alloys is obtained by rapid cooling from the liquid state, for example according to line A in FIG. 2. Thus, the material freezes without giving atoms time to organize. This metastable structure therefore does not have a long-range order in contrast to crystalline materials. For some alloys, the critical cooling rate, in order to avoid the crystallization front (see line B tangential to the curved shapes), is several thousand K/s.

If cooling is not sufficiently rapid, the material crystallizes in part or entirely, which is generally detrimental to its properties, inter alia to its mechanical properties (fragility). However, in some cases, controlled partial crystallization is desired to adapt the mechanical properties to the application. To do this, the material in the amorphous state can be heated in a controlled manner from ambient temperature to a temperature above the glass transition temperature Tg. The material is thus brought into the supercooled domain and held there for a certain time depending on the temperature, so that crystals can form and grow (see line D in FIG. 3).

As discussed above, the high cooling rates required to obtain an amorphous structure limit the implementation of such alloys, notably on the millimetric scale. In the family of metallic glasses, there is a subclass called bulk metallic glasses (BMG) which have a high thermal stability (glass forming ability, GFA) which represents the crystallization resistance of the material. This notion can be characterized by the measurement of a critical diameter Dc defined as being the maximum diameter of a cylinder that can be cast in order to obtain an entirely amorphous material.

The critical cooling rate for bulk metallic glasses is therefore lower than “standard” metallic glasses. As a result, semi-finished (near-net shape) components of millimetric or even centimetric size can be implemented, for example by injection from the liquid state or by thermoforming in the supercooled state.

Alternatively, the use of machining methods without force, typically by femtosecond laser, may be proposed. In view of the low material removal rate, these methods nevertheless need to be applied to preforms having dimensions quite close to the desired dimensions of the final part, such as those that can be obtained by the methods cited above. Electroerosion is also a suitable method for metallic glasses, notably for cutting 2D components from a plate.

There was therefore no method for manufacturing metallic glass bars that are several meters long and of millimetric cross section which could then be used to manufacture components by traditional machining, such as bar turning. In addition, those skilled in the art dismiss metallic glasses due to their poor suitability for machining, because of their fragility, their high hardness and their thermal sensitivity.

The applicant's research has shown that it is nevertheless possible to carry out hot drawing in the supercooling domain of bulk metallic glasses having a high thermal stability, the high thermal stability allowing sufficient time to implement this hot drawing step without the material crystallizing.

This makes it possible, by selecting a suitable alloy, to produce bars which can then be machined by a conventional means (bar turning).

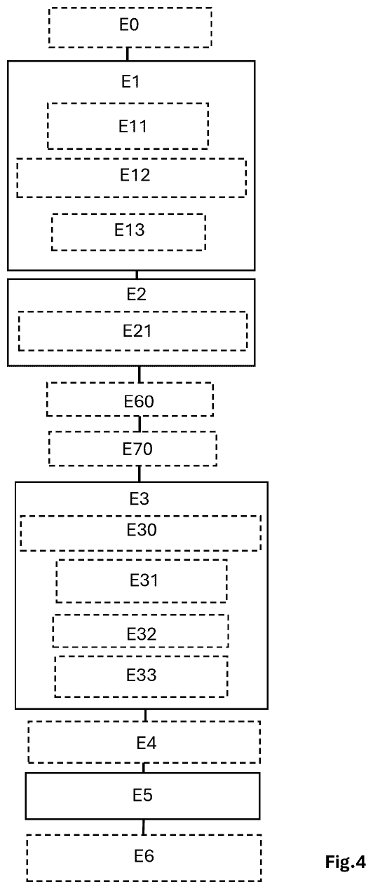

One embodiment of the method is described in more detail below with reference to FIG. 4. It is applied to an amorphous alloy based on palladium, notably Pd₄₃Cu₂₇Ni₁₀P₂₀ (at %). Its main characteristics are:
good wear resistance and a low coefficient of friction in typical timepiece conditions, for example a pivot in a ruby,
hardness: approximately 500 HV,
elastic limit: approximately 2000 MPa,
non-magnetic,
great thermal stability.

In a preliminary step E1, an alloy is melted at approximately 1000° C. and then cast in a water-cooled copper casting mold. The material is cooled at a rate higher than the critical cooling rate for this alloy. Thus, first preforms in the form of amorphous billets are produced with a diameter of 10 mm. The length of these preforms in the tests was between 10 and 20 cm. XRD (X-ray diffraction) and DSC (differential scanning calorimetry) analyses make it possible to confirm the amorphous state of such samples. The glass transition temperature Tg and transition temperature Tx measured by DSC at a rate of 20° C./min under argon are respectively Tg=316±5° C. and Tx=420±5° C.

In a second step E2, corresponding to a thermoforming step, the first preforms are subjected to hot drawing. The exploratory drawing tests were carried out on a machine specially constructed for drawing nanometric polymer and/or metallic glass fibers. The machine consists of a vertical frame on which a heating system is positioned in the upper part thereof and a drawing system in the lower part thereof (for example, a pulley or a capstan). A tension sensor is placed between the heating and drawing systems.

Feasibility tests were carried out without cladding and without gas protection. The first preforms used had a diameter of 10 mm and a length of 20 cm.

The first preform, held at the upper part thereof by a jaw, is placed vertically in the heating system. The latter may consist of different heating elements in order to have zones with different temperatures. The middle zone is the hottest zone in which the drawing process is carried out. A typical temperature for this zone is 380° C. The temperature of the zones depends on the dimensions of the preform and the alloy, and it can change during the drawing process. The temperature in the middle zone is controlled in the range Tx−Tg in order to reach the amorphous alloy viscosity in the range of 10⁷-10⁴ Pa·s.

In order to initiate the drawing, a force must be applied to the first preform. One solution is to make a hole in the lower part of the preform, allowing a wire supporting a weight to pass through.

The feed rate of the preform in the heating system and the drawing rate are parameters that can be adjusted depending on, inter alia, the diameter of the preform and the desired diameter of the drawn wire, and are for example 2 mm/min and 60 mm/min, respectively.

The first preform is hot-drawn without a die and under air. Several second preforms (in the form of wires) are obtained with a diameter varying between 1.7 and 1.9 mm over their entire length, of approximately 1.5 m.

In a third step E60, centerless grinding is carried out. A cylindrical grinding technique is thus implemented to obtain wires with an adequate dimensional tolerance necessary for then being able to machine high-precision components by bar turning. A tolerance h6 (+0; −6 μm for a wire of Ø2 mm) over a length of at least 1 m is typical for free-cutting wires.

In a fourth step E3, shafts, notably balance staffs, are machined, in particular dry-machined, on a turning machine, with diamond or coated tools.

In a fifth step E5, finishing is carried out. Notably, tribofinishing of the parts obtained at the end of the fourth step E4 is carried out.

One exemplary embodiment has been described above applied to a Pd-based metallic glass. However, the production method can be applied to any other bulk metallic glass, in particular to any alloy listed in the table below.

| Composition [at %] | D_{c} [mm] | T_{g} [K] | T_{L} [K] | ΔTₓ [K] |
|---|---|---|---|---|
| Pd₄₃Ni₁₀Cu₂₇P₂₀ | 30 | 305 | 554 | 131 |
| Pt_{57.5}Cu_{14.7}Ni_{5.3}P_{22.5} | 20 | 236 | 540 | 98 |
| Pd₇₅Si₁₅Ag₃Cu₇ | 10 | 348 | 756 | 74 |
| Zr_{41.2}Ti_{13.8}Cu_{12.5}Ni₁₀Be_{22.5} | 14 | 349 | 714 | 77 |

This list is not exhaustive. Preferably, the alloy used has the following characteristics:
a supercooling domain ΔTx≥40 K (where ΔTx=Tx−Tg), and
a critical diameter greater than 6 mm.

One exemplary embodiment has been described above using hot drawing as the thermoforming step. However, a thermoforming step of another nature can be implemented, notably extrusion.

A more general embodiment of the method according to the invention is also described below, also with reference to FIG. 4. It applies to a bulk amorphous metal alloy having a supercooling domain ΔTx=Tx−Tg greater than 40° C., preferably greater than 60° C., even more preferably greater than 100° C. The method is a method for producing a timepiece component, notably a shaft of a mobile of a regulating system, in particular a balance staff.

In a preliminary step E0, a pre-alloy of the amorphous or partially amorphous alloy is produced, for example by vacuum induction melting (VIM) or by arc melting.

In a first step E1, a first preform is shaped either by static casting in a casting mold, or by semi-continuous casting or by injection. The first preform is then constituted by an alloy in the amorphous state. The first preform is preferably in the form of a bar, more preferably in the form of a bar of round cross section with a diameter and a length greater than 6 mm and 10 cm, respectively, more preferably greater than 10 mm and 20 cm.

In one embodiment, the first step E1 comprises a first sub-step E11 dedicated to the structuring of the first preform. In one variant, the surface of the first preform is textured in order to obtain a predefined structure, which is drawn during a second step E2 of thermoforming (in particular hot drawing) so as to obtain a desired surface structure. In another variant, the structuring may be in the form of a section with a specific profile, such as a toothed profile, which is then maintained by homothetic deformation during the second step E2 of thermoforming by hot drawing. In the first sub-step E11, the structuring of the first preform may be obtained, for example, by machining or stamping, in order to produce, for example, toothed wheels, the toothing of pinions, profiled elements.

In one embodiment, a second sub-step E12 may comprise partial crystallization of the material of the first preform by a heat treatment in order to increase the hardness of the material. The crystalline-phase content is, for example, less than 60%, preferably less than 40%, more preferably less than 30%, even more preferably less than 5%, the percentages being expressed by volume of material.

In exploratory tests, pellets with a diameter of 10 mm and a thickness of 3 mm underwent an increase in hardness of approximately 10% after being heat-treated under vacuum for 40 min at a temperature of 370° C., then cooled rapidly at more than 100° C./min. The pellets after heat treatment had a crystalline-phase volume fraction of approximately 40%.

In a second step E2, the first preform is thermoformed, notably by hot drawing without a die under a controlled atmosphere, or under vacuum, or in air, to obtain a second preform. Preferably, in this thermoforming, the first preform is heated between the glass transition temperature Tg and the crystallization temperature Tx. Preferably, the second preform has at least one dimension exceeding the critical diameter Dc of the amorphous alloy (constituting the second preform) by a factor greater than 5, preferably greater than 10 or greater than 100 or greater than 1000. Preferably, the second preform is a rod, a bar or a wire, notably of round cross section with:
a diameter greater than 1 mm, preferably greater than 2 mm, and
a length greater than 0.5 m, preferably greater than 1 m or greater than 2 m. In another embodiment, this second step E2 comprises hot drawing under a controlled atmosphere, or even under vacuum, to protect the bulk metallic glass against oxidation.

In one embodiment, in the second step E2, a fourth heat treatment sub-step E21 is carried out in which the second preform is partially crystallized before a third machining step E3 in order to increase the hardness of the second preform.

In a third step E3, the second preform is machined with a method requiring a force, that is to say that the second preform is machined by chip removal or by abrasion, for example by grinding. The machining step E3 may comprise a sub-step E31 of bar turning.

The third step E3 may also comprise, possibly after the sub-step E31, a sub-step E33 of rolling the preform in order:
to achieve dimensional tolerances, and/or
to improve the surface condition of the pivots in the case of a shaft.

The third step E3 may also comprise, possibly after the sub-step E31 and/or before the sub-step E33, an additional sub-step E32 of cutting a toothing, for example of cutting a toothing of an escape pinion.

The third step E3 may also, possibly after the sub-step E31 and/or after the sub-step E32 and/or after the sub-step E33, optionally precede a step E4 of hardening the preform by a partial crystallization heat treatment.

In a fifth step E5, a step of finishing, in particular a step of tribofinishing, of the preform is carried out in order to remove the burrs and ensure an optimal surface condition of the finished timepiece component.

In one embodiment, in an additional sixth step E6, surface hardening of the component resulting from the third step E3 or of the timepiece component resulting from the fourth step E4 or resulting from the fifth step E5 is carried out. To carry out this surface hardening, a thermochemical treatment or a treatment by ion implantation is implemented, for example. In one embodiment, the tribofinishing step may precede the surface hardening.

Regardless of the embodiment or the variant, the production method may comprise:
a) in the first step E1, a third sub-step E13 of cladding the first preform in a material having a viscosity comparable to the metal alloy of the first preform at the drawing temperature, for example by means of a polymer cladding (for example a PEI (polyetherimide) on a platinum-based metallic glass preform such as Pt_{57.5}Cu_{14.7}Ni_{5.3}P_{22.5}) or by means of a mineral glass cladding (for example a phosphate glass on a palladium-based metallic glass preform),
b) in the second step E2, the drawing of the first bi-material (cladded) preform, and
c) in the third step E3, a fifth sub-step E30 of removing the cladding, for example by dissolution, by chemical attack or by machining, in order to release the metal part. For example, a PEI cladding may be dissolved in a solution of N-methyl-2-pyrrolidone.

Regardless of the embodiment or the variant, the production method may comprise, between the second step E2 and the third step E3, an additional step E60 of grinding, for example centerless grinding, of the second preform in order to produce a modified preform. In particular, the modified preform has a round cross section with a diameter within the tolerances necessary for automatic precision bar turning, typically of h6 on the diameter (+0 μm; −6 μm for a diameter of 2 mm).

Regardless of the embodiment or the variant, the production method may comprise, after step E2 or after step E60, an additional step E70 of cold drawing through a die to obtain a narrower tolerance range on the diameter of +0 μm; −3 μm, to form a further modified preform. During this operation, the reduction in cross section is less than 20%, preferably less than 10%, more preferably less than 5%. In one embodiment, in this step E70, the second preform or the modified preform is drawn through a die with a profiled shape, for example with a toothing shape.

The method according to the invention relates to the production of a timepiece component, notably a timepiece shaft. Before the end of the method, the partially produced timepiece component is denoted by the term “preform”. In particular, at the end of the first step E1, the partially produced timepiece component is denoted by the term “first preform” and, at the end of the second step E2, the partially produced timepiece component is denoted by the term “second preform”.

In the figures, the steps and the sub-steps represented by rectangles in dotted lines are optional steps.

As can be deduced from the foregoing description, throughout this document, “hot drawing” is understood to mean a process distinct from extrusion, notably in that hot drawing does not use a die. The absence of a die notably makes it possible to obtain a better surface condition by avoiding contact interaction with a die. The absence of interaction also makes it possible to avoid exceedance of the crystallization temperature Tx. Lastly, the absence of interaction makes it possible to prevent contamination.

1. A method for producing a timepiece component made of amorphous metal alloy, the production method comprising:
producing a first preform made of amorphous metal alloy, then
hot drawing the first preform to obtain a second preform, then
machining the second preform.

2. The method as claimed in claim 1, wherein the amorphous metal alloy has a supercooling domain ΔTx=Tx−Tg greater than 40° C., Tx being a crystallization temperature and Tg being a glass transition temperature.

3. The method as claimed in claim 1, wherein the amorphous metal alloy is a Pd-based alloy, or a Pt-based alloy, or a Zr-based alloy.

4. The method as claimed in claim 1, wherein the producing of the first preform comprises structuring the first preform.

5. The method as claimed in claim 1, wherein the producing of the first preform comprises hardening the material of the first preform by a crystallization heat treatment.

6. The method as claimed in claim 1, wherein the hot drawing of the first preform comprises hot drawing without a die in order to obtain the second preform having at least one dimension exceeding a critical diameter of the amorphous metal alloy by a factor greater than 5.

7. The method as claimed in claim 1, wherein the second preform is a rod or a bar or a wire having:
a diameter greater than 1 mm, and/or
a length greater than 0.5 m.

8. The method as claimed in claim 1, wherein the producing of the first preform made of amorphous metal alloy comprises cladding the amorphous metal alloy with a thermoplastic material.

9. The method as claimed in claim 8, wherein the machining of the second preform comprises removing the cladding.

10. The method as claimed in claim 1, wherein the hot drawing of the first preform comprises hardening by a partial crystallization heat treatment.

11. The method as claimed in claim 1, wherein the method further comprises, between the hot drawing of the first preform and the machining of the second preform, an additional shaping comprising:
grinding, and/or
drawing through a die.

12. The method as claimed in claim 1, wherein the machining of the second preform comprises machining with the application of a force.

13. The method as claimed in claim 1, wherein the machining comprises rolling.

14. The method as claimed in claim 1, wherein the machining of the second preform comprises cutting a toothing.

15. The method as claimed in claim 1, wherein the method comprises, after the machining of the second preform, hardening by a partial crystallization heat treatment.

16. The method as claimed in claim 15, wherein the method comprises, after the hardening, finishing the second preform.

17. The method as claimed in claim 1, wherein the method comprises, after the machining, finishing the second preform.

18. The method as claimed in claim 1, wherein the method comprises a preliminary of manufacturing of a pre-alloy of the amorphous or partially amorphous alloy.

19. A timepiece component obtained by implementing the method as claimed in claim 1.

20. The method as claimed in claim 3, wherein the amorphous metal alloy has a composition in atomic percentage selected from the group consisting of: [chemical structure]
